(19) United States
(12) Patent Application Publication
(10) Pub. No.: US 2025/0221563 A1
(43) Pub. Date: Jul. 10, 2025

(54) CONTAINER FOR USE WITH A MACHINE FOR PREPARING A BEVERAGE AND/OR FOODSTUFF, SYSTEM, USE, AND METHODS OF ENCODING AND READING PREPARATION INFORMATION

(71) Applicant: SOCIÉTÉ DES PRODUITS NESTLÉ S.A., Vevey (CH)

(72) Inventors: ALEXANDRE PERENTES, Sullens (CH); STEFAN KAESER, Aarau (CH); CHRISTIAN OGGENFUSS, Lyss (CH)

(21) Appl. No.: 18/850,753

(22) PCT Filed: Mar. 31, 2023
(86) PCT No.: PCT/EP2023/058527

§ 371 Date: Sep. 25, 2024

(30) Foreign Application Priority Data
Mar. 31, 2022 (EP) 22166221.6

(51) Int. Cl. A47J 31/44; G06K 7/10; G06K 19/06

(52) U.S. Cl. CPC A47J 31/4492; G06K 7/10613; G06K 19/06168

(57) ABSTRACT

A container arranged for containing a precursor material for use with a machine for preparing a beverage and/or foodstuff, the container including a machine-readable code storing preparation information for use with a preparation process performed by said machine, the code comprising a plurality of elements, wherein the elements of the code are arranged circumferentially to be read sequentially when the container is rotated about an axis of rotation relative a code reader, wherein the code is arranged as a plurality of directly adjoining discrete positions and an absence or presence of a primary element at a discrete position encodes the preparation information, wherein boundary elements are arranged at a boundary between two or more adjoining primary elements, and/or at a boundary between two or more adjoining absences of primary elements, and the boundary elements are of different reflective properties to a primary element or an absence of a primary element.

### TECHNICAL FIELD

The present disclosure relates generally to electrically operated beverage or foodstuff preparation systems, with which a beverage or foodstuff is prepared from a pre-portioned capsule.

### BACKGROUND

Systems for the preparation of a beverage comprise a beverage preparation machine and a capsule. The capsule comprises a single-serving of a beverage forming precursor material, e.g. ground coffee or tea. The beverage preparation machine is arranged to execute a beverage preparation process on the capsule, typically by the exposure of pressurized, heated water to said precursor material. Processing of the capsule in this manner causes the at least partial extraction of the precursor material from the capsule as the beverage.

This configuration of beverage preparation machine has increased popularity due to 1) enhanced user convenience compared to a conventional beverage preparation machines (e.g. compared to a manually operated stove-top espresso maker) and 2) an enhanced beverage preparation process, wherein: preparation information encoded by a code on the capsule is read by the machine, and; the preparation information is used by the machine to optimise the preparation process in a manner specific to the capsule. In particular, the encoded preparation information may comprise operating parameters selected in the beverage preparation process, including: fluid temperature; fluid pressure; preparation duration, and; fluid volume.

Various codes have been developed, an example of which is provided in EP 2594171 A1, wherein a lower side of a flange of a capsule comprises a code arranged thereon. The capsule is rotated by the machine to achieve code reading by relative rotation between the code and a code reader on the machine.

A drawback of such a code is that reading of the code, particularly when a rate of rotation of the code is unknown, can be unreliable.

Therefore, in spite of the effort already invested in the development of said systems further improvements are desirable.

### SUMMARY

The present disclosure provides a container for containing a precursor material for use with a machine for preparing a beverage or foodstuff (including a precursor thereof), the container including a machine-readable code storing preparation information for use with a preparation process performed by said machine, in which the machine is controlled based on the preparation information to prepare the beverage and/or foodstuff.

The code is arranged as a plurality of directly adjoining (e.g. with no gap therebetween so that adjoining edges directly bound each other) discrete positions and an absence or presence of a primary element at a discrete position encodes the preparation information (e.g. as a logical 1 or a 0). The discrete positions are all of the same geometry. Boundary elements are arranged at a boundary between two or more adjoining primary elements, and/or at a boundary between two or more adjoining primary element absences. The boundary elements are of different reflective and/or optical properties to a primary element and/or an absence of a primary element.

In embodiments, the discrete positions and the boundary elements of the code are arranged circumferentially (e.g. along a circular, circumferentially extending line) to be read sequentially (e.g. one unit after another when the container is rotated about an axis of rotation relative a code reader).

By arranging the boundary elements between adjoining elements or adjoining primary element absences, the code may be more accurately processed to identify individual primary elements or primary element absences. Alternatively, it may be easier to inspect to see if the code has been properly formed.

The individual primary elements/absence thereof, may be particularly easier to identify when the code is read at a high or an unknown speed, since long series of primary elements may otherwise be identified as a single code signal value (as is the case for long series of primary element absences). Instead the boundary elements introduce fluctuations in the signal that enable the individual primary elements/absences thereof to be identified.

The inventive arrangement may obviate the need for a restriction in a maximum number of primary elements/absences thereof that are allowed to adjoin each other, which in the prior art may be set at 3, 4, 5 or 7. In embodiments, the code is arranged with 4, 5, 6, 7, 8, 9 or 10 primary elements that are allowed to directly adjoin each other. The same may apply for primary element absences.

Moreover, since a number of primary elements can be determined with high accuracy, the code signal can be processed with minimal read errors. In addition, since a number of primary elements/absences thereof in a rotation of the container can be accurately determined, the code signal can be used to determine an angular velocity of a container. This may obviate the need for a separate encoder to determine angular velocity of the container, thereby simplifying the machine.

As used herein the term “reflective properties” may refer to one or more of a: reflectance; reflectivity; other related optical properties; the aforesaid for particular wavebands, including particular colours in the visible spectrum. It may include the fraction of power reflected or absorbed at a specific position, with a fraction not being reflected at said position, e.g. due to absorption and/or transmission diffusely rather than as specula reflection. The reflective properties may be measured in a suitable wave band, e.g. one or more of the infra-red; the visible, and; ultraviolet waveband. The infra-red waveband may be limited to 830-870 nm. The ultraviolet waveband may be limited to 300-400 nm. The visible waveband may be limited to 380 to about 750 nm. For boundary elements which are non-uniform in composition (e.g. due to raster printing) the reflective properties may be calculated as an average, or over a representative area, e.g. for the whole element.

In embodiments, the boundary elements are configured to be visible (including only visible) to a code reader in other wave bands (e.g. those other to infrared including visible and/or ultra violet wave bands) and: may not be visible to the code reader in the infrared wavebands (including not visible over a particular wave band range within the infrared spectrum). In this manner the boundary elements may not interfere with existing machines with code reading systems that operate in the infrared wave bands, but can be identified by new machines with code reading systems that operate in the infrared and other wave bands. Alternatively, the boundary elements may have the same visibility as a primary element or primary element absence in the infrared wavebands. In this manner the boundary elements may not interfere with existing machines with code reading systems that operate in the infrared wave bands (since they may be identified simply as an extension of primary element or primarily element absence to which they adjoin) but can be identified by new machines with code reading systems that operate in the infrared and other wave bands. Such arrangements may be achieved by the use of suitable inks or paint, e.g. UV and IR absorbing inks etc.

In embodiments, the code reader may be implemented as separate readers, e.g. one in the infrared and one in the other wavebands. Hence a dedicated code reader may be implemented for reading the boundary elements.

In embodiments, the boundary elements are configured not to be visible to code reader in the same wave bands as the primary element and primary element absence.

In embodiments, the boundary elements are only arranged at a boundary between two or more adjoining primary elements, and/or at a boundary between two or more adjoining primary element absences so that a boundary between a primary element and an primary element absence does not include a boundary element.

By only arranging the boundary elements at the junction of two primary elements or two primary element absences, a boundary element is not arranged at a boundary between a primary element and a primary element absence. In this manner, a number of boundary elements in the code may be minimised, since they are unnecessary between a primary element and a primary element absence because a code reading program can more easily identify such transitions in the signal without requiring a boundary element being present. It may be desirable to minimise a number of boundary elements present for retro-compatibility with existing machines that do not implement a more sophisticated code processing program that identifies individual primary elements using a boundary element.

In embodiments, boundary elements are arranged at all boundaries between two or more adjoining primary elements, and/or at all boundaries between two or more adjoining primary element absences. In embodiments, all boundaries of a primary element and primary element absence do not comprise a boundary element.

In embodiments, the boundary elements entirely separate the adjoining primary elements and/or primary element absences. By arranging the boundary elements to entirely separate adjoining primary elements, the individual primary elements may be conveniently located in the code. The same being understood for the primary elements absences.

In embodiments, a boundary element does not encode the preparation information, e.g. they are just present to enable differentiation between primary elements that are adjoining, the same being understood for the primary element absences.

In embodiments, the boundary elements have: have an average arc length of less than 50% or 40% or 30% or 25% or 20% of an average arc length of a discrete position. In embodiments, the boundary elements have: have an average arc length of greater than 2.5% or 5% or 10% or 15% of an average arc length of a discrete position.

Such a range for the boundary elements has been found to enable reading of the boundary elements, without compromising retro-compatibility with existing machines that do not implement a more sophisticated code processing program that identifies individual primary elements using a boundary element.

As used herein an “average arc length” may refer to the average of the arc lengths (e.g. in degrees or radian) taken along the radial direction of an element.

In embodiments, the discrete positions have an average arc length of 2.6 degrees±30% or 20% or 10% or 5%. In embodiments, the boundary elements have an average arc length of 0.5 degrees or 0.44 degrees±5% or 10% or 20% or 30%. Such a size range for boundary elements and discrete positions has been found to enable locating of the boundary elements, without compromising retro-compatibility with existing machines that do not implement a more sophisticated code processing program that identifies individual primary elements using a boundary element.

In embodiments, the boundary elements and/or discrete positions are arched shaped, rectilinear (including rectangular) or are a combination thereof.

In embodiments, a primary element arranged at a discrete position is configured to reflect less power (e.g. when subject to an incident beam) in the infrared wavebands than a primary element absence, and; a boundary element is configured to reflect more power in the infrared wavebands than the primary element and less power in the infrared wavebands than the primary element absence. In embodiments, a primary element absence arranged at a discrete position is configured to reflect less power (when subject to an incident beam) in the infrared wavebands than a primary element, and; a boundary element is configured to reflect more power in the infrared wavebands than the primary element absence and less power in the infrared wavebands than the primary element. It will be understood for clarity that less and more are defined relative to each other.

By implementing the boundary element to have different power reflection properties to the primary element and the primary element absence, the boundary elements may be conveniently identified when reading the code in the infrared wavebands.

In particular, by forming the primary elements to be absorbent and a primary element absence to be comparatively reflective to electromagnetic radiation in the infrared wavebands, when reading the signal one may be conveniently assigned a logical 1 and the other a logical zero (or other high and low value). The boundary element being between the two, may be clearly identified with another value.

In embodiments, a boundary element is configured to reflect the same power in the infrared wavebands as an adjoining primary element or primary element absences and have different reflective properties from the primary element and primary element absence in other wave bands (e.g. those other to infrared including visible and ultra violet wave bands).

By implementing the boundary element to have the same reflective properties in the infrared wavebands as the primary element or primary element absence it adjoins, existing or legacy machines which do not have code processing programs to identify boundary elements may read the code without disruption, hence the code is retro compatible. However, since the boundary elements have different reflective properties in the visible spectrum, they can be identified with suitable code processing programs of compatible machines, and the benefits disclosed herein used during processing.

In embodiments an experimental set up comprises: a 850 nm, 520 μW laser source, projecting a distance of 21 mm to a Nt62-593 lens with a 3.4 mm aperture and a distance of 100 mm from said lens to the code at an angle of incidence to a normal to the code of 6.7 degrees, and; a photo sensitive detector at 850 nm, arranged a distance of 28 mm from a Nt45-504 lens with a 3.4 mm aperture and a distance of 160 mm from said lens to the code at an angle of reflection to a normal to the code of 1.2 degrees. For the experimental setup, the spot size/sample size of the code may have a diameter 0.5-2 mm or be averaged.

For said experimental setup a primary element is configured to reflect less than 0.4 μW(±20% or 10% or 5%); a primary element absence is configured to reflect more than 1.1 μW(±20% or 10% or 5%).

A boundary may be is configured to reflect greater than 0.4 μW(±20% or 10% or 5% e.g. but with non-overlapping ranges to the primary element) and less than 1.1 μW(±20% or 10% or 5% e.g. but with non-overlapping ranges to the primary element absence).

The converse may be implemented, e.g. with a primary element configured to reflect more than 1.1 μW and a primary element absence configured to reflect less than 0.4 μW etc.

For said experimental setup a boundary element may be configured to reflect the same power as an adjoining primary element or primary element absence and have different reflective properties from the primary element and primary element absence in the visible wave bands.

In embodiments the primary elements and/or primary elements absences, and; the boundary elements, are formed by printing. By forming the elements, or absence of elements, by printing the code may be conveniently formed directly on the container or on a substrate that is subsequently connected to a container. In embodiments, the primary elements or primary element absences comprise a greater density and/or size of units forming the print than the boundary elements. By forming the boundary elements from the same printing process (e.g. via raster printing) as the primary elements or primary element absences, the code may be conveniently formed.

In embodiments, the discrete positions encode a logical 1 or 0 based on the absence or presence of a primary element. In embodiments, the code is encoded with a predetermined sequence of logical 0s and 1s defining locator sequence for locating a data sequence of logical 0s and 1s.

In embodiments, the container includes a body with a storage portion, for storage of precursor material; a closing member (e.g. a membrane) for closing the storage portion. In embodiments, the body includes a flange portion connecting the storage portion and closing member. The container may be rotationally symmetric about an axis of rotation. In embodiments, the code is arranged on an exterior wall of the flange portion, wherein said exterior wall faces away from an exterior wall of the closing member, e.g. the code is on the other side of the flange portion to the closing member.

The present disclosure provides a system comprising the container of any preceding embodiment or another embodiment disclosed herein and a machine as disclosed herein for preparing a beverage and/or foodstuff.

The present disclosure provides a substrate configured for attachment to a container arranged for containing a precursor material for use with a machine for preparing a beverage and/or foodstuff, the substrate including a machine-readable code. The code may comprise the features of any preceding embodiment or another embodiment disclosed herein. The substrate may include an adhesive label or other suitable implementation.

The present disclosure provides a machine for preparing a beverage and/or foodstuff or a precursor thereof, the machine including: a code reading system to read the code of the container or any preceding embodiment, or another embodiment disclosed herein based on relative rotation between a code reader and the code; a processing unit for processing the precursor material of the container, and; electrical circuitry to control the processing unit based on preparation information read from the code. The machine may be arranged to execute any of the methods disclosed herein.

In embodiments, the code reading system is arranged to read the code as the container is rotated about an axis of rotation, and the processing unit is arranged to process the precursor material as the container is rotated about said axis of rotation. Code reading and precursor material processing may be executed concurrently or consecutively.

The present disclosure provides use of the container of any preceding embodiment or another embodiment disclosed herein for a machine as disclosed herein for preparing a beverage and/or foodstuff or a precursor thereof.

The present disclosure provides a method of reading preparation information for use in a preparation process, in which a machine is controlled based on the preparation information to prepare a beverage and/or foodstuff, the method comprising: implementing relative rotation between a container comprising a code and a code reader; obtaining a signal from the code reader based on the code; processing the signal to identify in said signal an absence or presence of a primary element at a discrete position based on identifying an boundary element arranged at a boundary between two adjoining primary elements, and/or at a boundary between two adjoining primary element absences, and; extracting the preparation information based on the identified absence or presence of a primary element. The method may implement the features of any preceding embodiment or another embodiment disclosed herein.

The present disclosure provides a method of determining an angular velocity of a container or use with a machine for preparing a beverage and/or foodstuff, the method comprising: implementing relative rotation between a container comprising a code and a code reader; obtaining a signal from a code reader based on the code; processing the signal to identify in said signal an absence or presence of a primary element at a discrete position based on identifying an boundary element arranged at a boundary between two adjoining primary elements, and/or at a boundary between two adjoining primary element absences, and; determining the angular velocity based on there being a known number of discrete positions per full rotation of the code. The method may implement the features of any preceding embodiment or another embodiment disclosed herein.

In embodiments, the boundary elements are identified in the signal based on them having different reflective properties to a primary element and/or a primary element absence. In other examples, the reflective properties may be the same as one of a primary element or primary element absence, with the other of the a primary element or primary element absence being arranged on either side of the boundary element.

The present disclosure provides a method of reading preparation information for use in a preparation process in which a machine is controlled based on the preparation information to prepare a beverage and/or foodstuff, the method comprising: implementing relative rotation between the container any preceding embodiment or another embodiment disclosed herein and a code reader; obtaining a signal from the code reader based on the code; processing the signal to identify in said signal an absence or presence of a primary element at a discrete position without identifying the boundary elements in the signal, and; extracting the preparation information based on the identified absence or presence of a primary element. The method, for example, is implemented on an existing/legacy machine which does not comprise a code processing program configured to identify the boundary elements, instead it only identifies the discrete positions, such that the code can be adequately processed.

In embodiments, the boundary elements are identified in the signal based on them having different reflective properties to a primary element and/or primary element absences.

The methods may be implemented as part of a method of preparing a beverage or foodstuff or a precursor thereof, in which a processing unit is controlled based on the preparation information to execute a preparation process on the precursor material.

The present disclosure provides a method of encoding preparation information with a code, the method comprising: forming the code as a plurality of directly adjoining discrete positions, with an absence or presence of a primary element in a discrete position encoding the preparation information, forming boundary elements at a boundary of two adjoining primary elements, and/or at a boundary of two adjoining primary element absences, wherein the boundary elements are formed with different reflective properties to a primary element or a primary element absence, wherein the discrete positions and the boundary elements of the code are arranged circumferentially to be read sequentially when the container is rotated about an axis of rotation relative a code reader. The method may implement the features of any preceding embodiment or another embodiment disclosed herein.

The present disclosure provides electrical circuitry and/or a computer program, which may be executable on one or more processors (e.g. of the system), to implement the method of the preceding embodiments or another embodiment disclosed herein.

The present disclosure provides a computer readable medium comprising program code, which may be executable on one or more processors (e.g. of the system), to implement the method of the preceding embodiments or another embodiment disclosed herein.

The preceding summary is provided for purposes of summarizing some embodiments to provide a basic understanding of aspects of the subject matter described herein. Accordingly, the above-described features are merely examples and should not be construed to narrow the scope or spirit of the subject matter described herein in any way. Moreover, the above and/or proceeding embodiments may be combined in any suitable combination to provide further embodiments. Other features, aspects, and advantages of the subject matter described herein will become apparent from the following Detailed Description of Embodiments, Brief Description of Figures, and Claims.

### BRIEF DESCRIPTION OF FIGURES

Aspects, features and advantages of embodiments of the present disclosure will become apparent from the following detailed description of embodiments in reference to the appended drawings in which like numerals denote like elements.

FIG. 1 is a block system diagram showing an embodiment system for preparation of a beverage or foodstuff or a precursor thereof.

FIG. 2 is a block system diagram showing an embodiment machine of the system of FIG. 1.

FIG. 3 is an illustrative diagram showing an embodiment fluid conditioning system of the machine of FIG. 2.

FIGS. 4A and 4B and 5 are illustrative diagrams showing an embodiment container processing system of the machine of FIG. 2.

FIG. 6 is a block diagram showing embodiment control electrical circuitry of the machine of FIG. 2.

FIG. 7 is an illustrative diagram showing embodiment container of the system of FIG. 1.

FIG. 8 is flow diagram showing an embodiment preparation process, which is performed by the system of FIG. 1.

FIGS. 9 and 10 are a plan views to scale showing a code of the container of FIG. 7.

FIGS. 11 and 12 are illustrative views showing the code of FIGS. 9 and 10.

FIGS. 13 and 14 are illustrative views showing an experimental test set up for measuring the code.

FIG. 15 is a graphical plot showing a code read signal obtained when reading the code of any of FIGS. 9-12.

### DETAILED DESCRIPTION OF EMBODIMENTS

Before describing several embodiments of the system, it is to be understood that the system is not limited to the details of construction or process steps set forth in the following description. It will be apparent to those skilled in the art having the benefit of the present disclosure that the system is capable of other embodiments and of being practiced or being carried out in various ways.

The present disclosure may be better understood in view of the following explanations:

As used herein, the term “machine” may refer to an electrically operated device that: can prepare, from a precursor material, a beverage and/or foodstuff, or; can prepare, from a pre-precursor material, a precursor material that can be subsequently prepared into a beverage and/or foodstuff. The machine may implement said preparation by one or more of the following processes: dilution; heating; cooling; mixing; whisking; dissolution; soaking; steeping; extraction; conditioning; infusion; grinding, and; other like process. The machine may be dimensioned for use on a work top, e.g. it may be less than 70 cm in length, width and height. As used herein, the term “prepare” in respect of a beverage and/or foodstuff may refer to the preparation of at least part of the beverage and/or foodstuff (e.g. a beverage is prepared by said machine in its entirety or part prepared to which the end-user may manually add extra fluid prior to consumption, including milk and/or water).

As used herein, the term “container” may refer to any configuration to contain the precursor material, e.g. as a single-serving, pre-portioned amount. The container may have a maximum capacity such that it can only contain a single-serving of precursor material. The container may be single use, e.g. it is physically altered after a preparation process, which can include one or more of: perforation to supply fluid to the precursor material; perforation to supply the beverage/foodstuff from the container; opening by a user to extract the precursor material. The container may be configured for operation with a container processing unit of the machine, e.g. it may include a flange for alignment and directing the container through or arrangement on said unit. The container may include a rupturing portion, which is arranged to rupture when subject to a particular pressure to deliver the beverage/foodstuff. The container may have a closing member, e.g. a membrane, for closing the container. The container may have various forms, including one or more of: frustoconical; cylindrical; disk; hemispherical; other like form. The container may be formed from various materials, such as metal or plastic or paper a combination thereof. The material may be selected such that it is: food-safe; it can withstand the pressure and/or temperature of a preparation process. The container may be defined as a capsule, wherein a capsule may have an internal volume of 20-100 ml. The capsule includes a coffee capsule, e.g. a Nespresso® capsule (including a Classic, Professional, Vertuo, Dolce Gusto or other capsule). The container may be defined as a receptacle for end user consumption therefrom.

As used herein, the term “external device” or “external electronic device” or “peripheral device” may include electronic components external to the machine, e.g. those arranged at a same location as the machine or those remote from the machine, which communicate with the machine over a computer network. The external device may comprise a communication interface for communication with the machine and/or a server system. The external device may comprise devices including: a smartphone; a PDA; a video game controller; a tablet; a laptop; or other like device.

As used herein, the term “server system” may refer to electronic components external to the machine, e.g. those arranged at a remote location from the machine, which communicate with the machine over a computer network. The server system may comprise a communication interface for communication with the machine and/or the external device. The server system can include: a networked-based computer (e.g. a remote server); a cloud-based computer; any other server system.

As used herein, the term “system” or “beverage or foodstuff preparation system” may refer to the combination of any two of more of: the beverage or foodstuff preparation machine; the container; the server system, and; the peripheral device.

As used herein, the term “beverage” may refer to any substance capable of being processed to a potable substance, which may be chilled or hot. The beverage may be one or more of: a solid; a liquid; a gel; a paste. The beverage may include one or a combination of: tea; coffee; hot chocolate; milk; cordial; vitamin composition; herbal tea/infusion; infused/flavoured water, and; other substance. As used herein, the term “foodstuff” may refer to any substance capable of being processed to a nutriment for eating, which may be chilled or hot. The foodstuff may be one or more of: a solid; a liquid; a gel; a paste. The foodstuff may include: yoghurt; mousse; parfait; soup; ice cream; sorbet; custard; smoothies; other substance. It will be appreciated that there is a degree of overlap between the definitions of a beverage and foodstuff, e.g. a beverage can also be a foodstuff and thus a machine that is said to prepare a beverage or foodstuff does not preclude the preparation of both.

As used herein, the term “precursor material” may refer to any material capable of being processed to form part or all of the beverage or foodstuff. The precursor material can be one or more of a: powder; crystalline; liquid; gel; solid, and; other. Examples of a beverage forming precursor material include: ground coffee; milk powder; tea leaves; coco powder; vitamin composition; herbs, e.g. for forming a herbal/infusion tea; a flavouring, and; other like material. Examples of a foodstuff forming precursor material include: dried vegetables or stock as anhydrous soup powder, powdered milk; flour based powders including custard; powdered yoghurt or ice-cream, and; other like material. A precursor material may also refer to any pre-precursor material capable of being processed to a precursor material as defined above, i.e. any precursor material that can subsequently be processed to a beverage and/or foodstuff. In an example, the pre-precursor material includes coffee beans which can be ground and/or heated (e.g. roasted) to the precursor material.

As used herein, the term “fluid” (in respect of fluid supplied by a fluid conditioning system) may include one or more of: water; milk; other. As used herein, the term “conditioning” in respect of a fluid may refer to a change in a physical property thereof and can include one or more of the following: heating or cooling; agitation (including frothing via whipping to introduce bubbles and mixing to introduce turbulence); portioning to a single-serving amount suitable for use with a single serving container; pressurisation e.g. to a brewing pressure; carbonating; fliting/purifying, and; other conditioning process.

As used herein, the term “processing unit” may refer to an arrangement that can process precursor material to a beverage or foodstuff. It may refer to an arrangement that can process a pre-precursor material to a precursor material. The processing unit may have any suitable implementation, including a container processing unit. The processing unit may be controlled by electrical circuitry to perform a preparation process based on preparation information.

As used herein, the term “container processing unit” may refer to an arrangement that can process a container to derive an associated beverage or foodstuff from a precursor material in the container. The container processing unit may be arranged to process the precursor material by one of more of the following: dilution; heating; cooling; mixing; whisking; dissolution; soaking; steeping; extraction; conditioning; pressurisation; infusion, and: other processing step. The container processing unit may therefore implement a range of units depending on the processing step, which can include: an extraction unit (which may implement a pressurised and/or a thermal, e.g. heating or cooling, brewing process); a mixing unit (which mixes a beverage or foodstuff in a receptacle; a dispensing and dissolution unit (which extracts a portion of the precursor material from a repository, processes by dissolution and dispenses it into a receptacle), and: other like unit.

As used herein, the term “electrical circuitry” or “circuitry” or “control electrical circuitry” may refer to one or more hardware and/or software components, examples of which may include: an Application Specific Integrated Circuit (ASIC); electronic/electrical componentry (which may include combinations of transistors, resistors, capacitors, inductors etc); one or more processors; a non-transitory memory (e.g. implemented by one or more memory devices), that may store one or more software or firmware programs; a combinational logic circuit; interconnection of the aforesaid. The electrical circuitry may be located entirely at the machine, or distributed between one or more of: the machine; external devices; a server system.

As used herein, the term “processor” or “processing resource” may refer to one or more units for processing, examples of which include an ASIC, microcontroller, FPGA, microprocessor, digital signal processor (DSP), state machine or other suitable component. A processor may be configured to execute a computer program, e.g. which may take the form of machine readable instructions, which may be stored on a non-transitory memory and/or programmable logic. The processor may have various arrangements corresponding to those discussed for the circuitry, e.g. on-board machine or distributed as part of the system. As used herein, any machine executable instructions, or computer readable media, may be configured to cause a disclosed method to be carried out, e.g. by the machine or system as disclosed herein, and may therefore be used synonymously with the term method, or each other.

As used herein, the term “computer readable medium/media” or “data storage” may include any medium capable of storing a computer program, and may take the form of any conventional non-transitory memory, for example one or more of: random access memory (RAM); a CD; a hard drive; a solid state drive; a memory card; a DVD. The memory may have various arrangements corresponding to those discussed for the circuitry.

As used herein, the term “communication resources” or “communication interface” may refer to hardware and/or firmware for electronic information transfer. The communication resources/interface may be configured for wired communication (“wired communication resources/interface”) or wireless communication (“wireless communication resources/interface”). Wireless communication resources may include hardware to transmit and receive signals by radio and may include various protocol implementations e.g. the 802.11 standard described in the Institute of Electronics Engineers (IEEE) and Bluetooth™ from the Bluetooth Special Interest Group of Kirkland Wash. Wired communication resources may include; Universal Serial Bus (USB); High-Definition Multimedia Interface (HDMI) or other protocol implementations. The machine may include communication resources for wired or wireless communication with an external device and/or server system.

As used herein, the term “network” or “computer network” may refer to a system for electronic information transfer between a plurality of apparatuses/devices. The network may, for example, include one or more networks of any type, which may include: a Public Land Mobile Network (PLMN); a telephone network (e.g. a Public Switched Telephone Network (PSTN) and/or a wireless network); a local area network (LAN); a metropolitan area network (MAN); a wide area network (WAN); an Internet Protocol Multimedia Subsystem (IMS) network; a private network; the Internet; an intranet.

As used herein, the term “code” may refer to a storage medium that encodes preparation information. The code may be an optically readable code, e.g. a bar code. The code may be arranged as a bit code (e.g. a binary sequence of 0s and 1s encoded by the absence or presence of an element). The code may be formed of a plurality of units, which can be referred to as elements or markers. The elements may implement a finder portion and a data portion, wherein the finder portion encodes a predefined reserved string of bits that is identifiable when processing the code from the data portion, to enable location of the data portion, which encodes the preparation information. The code may be arranged as a one dimensional code, which is read by relative movement between the code and a code reader. The code reader may provide a bit stream signal or a high and low signal for processing by preparation information extraction. It will be understood that a code may therefore exclude a mere surface finish or branding on a container, which is not configured in any way for information storage.

As used herein the term “preparation information” may refer to one of more of: parameters as defined herein; a recipe as defined herein; an identifier, and; other information related to the operation of the machine.

As used herein, the term “parameter” may refer to a variable that is used as an input for controlling (e.g. RPM) and/or or a property of the beverage/foodstuff or a precursor thereof that is controlled by the processing unit (e.g. a fluid target temperature or volume) during the preparation process. Depending on the implementation of the processing unit said parameter may vary. Examples include: volume of a particular component of the beverage and/or foodstuff; fluid temperature; fluid flow rate; operational parameters of the processing unit, e.g. RPM of an extraction unit based on centrifugation or closing force for a hydraulic brewing unit; an order of dispensing of components of the beverage and/or foodstuff; agitation (e.g. frothing degree); any of the aforesaid defined for one or more phases, wherein the preparation process is composed of a series of sequential, discrete phases. The parameter may have a value, which may be numerical and can vary in predetermined increments between predetermined limits, e.g. a temperature of the water may vary between 60-90 degrees in 5 degree increments.

As used herein, the term “recipe” or “control data set” may refer to a combination of said parameters, e.g. as a full or partial set of inputs, that are used by the processing unit to prepare a particular beverage and/or food stuff.

As used therein, the term “identifier” may refer to a unique sequence of bits that forms a key of a key-value database paradigm. Specifically a single identifier may relate to one or a predefined number of recipes which are stored on the electrical circuitry of the system. An identifier may be considered different to parameters that are encoded directly on the container, since the identifier does not encode a single parameter, instead it is linked by the key-value database paradigm a full of partial set that is the recipe.

As used herein the term “directly” or “direct” in respect of a value of a parameter encoded by the code, may refer to the parameter having a number of possible values that encode a magnitude of the associated parameter, with one of which being directly extractable from the code, rather than extractable along with a series of other parameters via an identifier and a look-up table. Alternatively put, it may refer to the encoding of a value that can vary independently of the other parameters of the recipe on code. For example, four bits may encode 1-16 magnitudes of water temperature with 1 being the lowest and 16 being the highest, these magnitudes may be scaled by a rule on the machine to provide an actual temperature used in the preparation process.

As used herein, the term “preparation process” may refer to a process to prepare a beverage or foodstuff from a precursor material or to prepare a pre-precursor material from precursor material. A preparation process may refer to the processes electrical circuitry executes to control the processing unit to process said precursor or pre-precursor material.

As used herein, the term “code reading process” may refer to the process of reading the code to extract the preparation information (which can include the identifier and/or parameters). The process may include one or more of the following steps: obtaining a digital image of the code or a code signal; extracting a sequence of bits from the code; identifying a finder portion of the code in the sequence; locating a data portion using the finder portion, and; extracting the preparation information from the data portion.

### General System Description

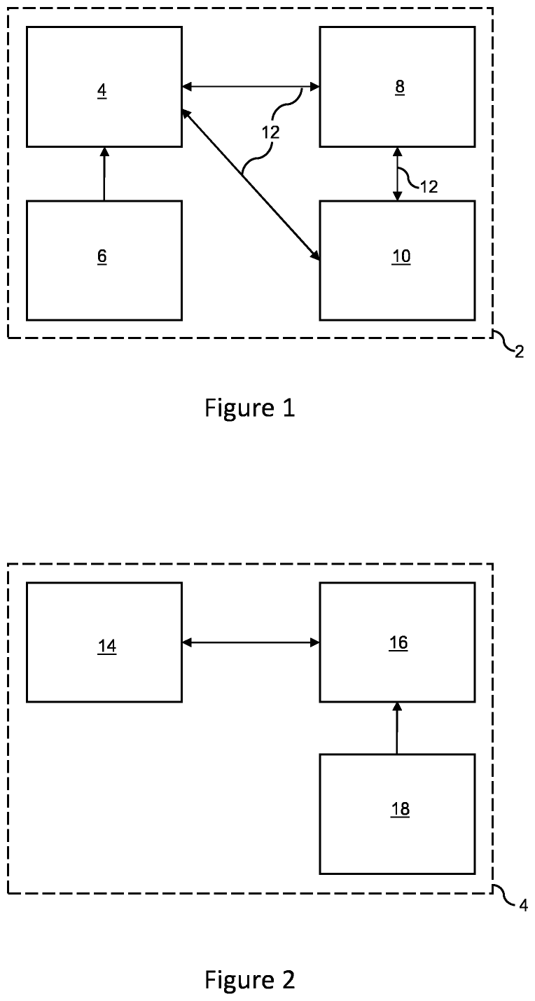

Referring to FIG. 1, the system 2 comprises a machine 4, a container 6, server system 8 and a peripheral device 10. The server system 8 is in communication with the machine 4 via a computer network 12. The peripheral device 10 is in communication with the machine 4 via the computer network 12.

In variant embodiments, which are not illustrated: the peripheral device and/or server system is omitted.

Although the computer network 12 is illustrated as the same between the machine 4, server system 8 and peripheral device 10, other configurations are possible, including: a different computer network for intercommunication between each device: the server system communicates with the machine via the peripheral device rather than directly. In a particular example: the peripheral device communicates with the machine via a wireless interface, e.g. with a Bluetooth™ protocol, and; the server system communicates with the machine via a via a wireless interface, e.g. with a IEE 802.11 standard, and also via the internet.

### Machine

Referring to FIG. 2, the machine 4 comprises: a processing unit 14 for processing the precursor material; electrical circuitry 16, and; a code reading system 18.

The electrical circuitry 16 controls the code reading system 18 to read a code (not illustrated in FIG. 2) from the container 6 and determine preparation information therefrom. The electrical circuitry 16 uses the preparation information to control the processing unit 14 to execute a preparation process, in which the precursor material is process to a beverage or foodstuff or a precursor thereof.

### Processing Unit

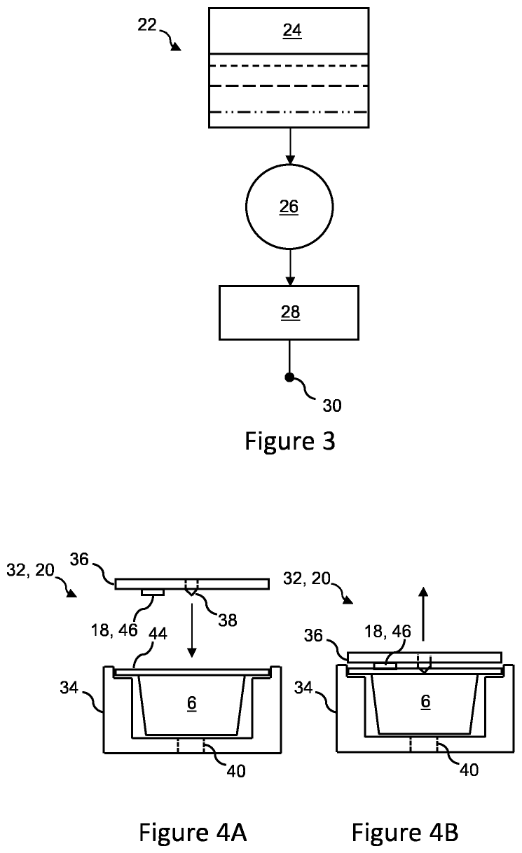

Referring to FIGS. 2 and 3, in a first example of the processing unit 14, said unit comprises a container processing unit 20 and a fluid conditioning system 22.

The container processing unit 20 is arranged to process the container 6 to derive a beverage or foodstuff from precursor material (not illustrated) therein. The fluid conditioning system 22 conditions fluid supplied to the container processing unit 20. The electrical circuitry 16 uses the preparation information read from the container 6 to control the container processing unit 20 and the fluid conditioning system 22 to execute the preparation process.

### Fluid Conditioning System

Referring to FIG. 3, the fluid conditioning system 22 includes a reservoir 24; pump 26; heat exchanger 28, and; an outlet 30 for the conditioned fluid. The reservoir 24 contains fluid, typically sufficient for multiple preparation processes. The pump 26 displaces fluid from the reservoir 24, through the heat exchanger 26 and to the outlet 30 (which is connected to the container processing unit 20). The pump 26 can be implement as any suitable device to drive fluid, including: a reciprocating; a rotary pump; other suitable arrangement. The heat exchanger 28 is implemented to heat the fluid, and can include: an in-line, thermo block type heater; a heating element to heat the fluid directly in the reservoir; other suitable arrangement.

In variant embodiments, which are not illustrated: the pump is omitted, e.g. the fluid is fed by gravity to the container processing unit or is pressurised by a mains water supply; the reservoir is omitted, e.g. water is supplied by a mains water supply; the heat exchanger is arranged to cool the fluid, e.g. it may include a refrigeration-type cycle heat pump); the heat exchanger is omitted, e.g. a mains water supply supplies the water at the desired temperature; the fluid conditioning system includes a filtering/purification system, e.g. a UV light system, a degree of which that is applied to the fluid is controllable; a carbonation system that controls a degree to which the fluid is carbonated.

### Container Processing Unit

The container processing unit 20 can be implemented with a range of configurations, as illustrated in examples 1-6 below:

Referring to FIGS. 4A and 4B, a first example of the container processing unit 20 is for processing of a container arranged as a capsule 6 (a suitable example of a capsule is provided in FIG. 8, which will be discussed) to prepare a beverage. The container processing unit 20 is configured as an extraction unit 32 to extract the beverage from the capsule 6. The extraction unit 32 includes a capsule holding portion 34 and a closing portion 36. The extraction unit 32 is movable to a capsule receiving position (FIG. 4A), in which capsule holding portion 34 and a closing portion 36 are arrange to receive a capsule 6. The extraction unit 32 is movable to a capsule extraction position (FIG. 4B), in which the capsule holding portion 34 and a closing portion 36 form a seal around a capsule 6, and the beverage can be extracted from the capsule 6. The extraction unit 32 can be actuator driven or manually movable between said positions.

The outlet 30 of the fluid conditioning system 22 is arranged as an injection head 38 to inject the conditioned fluid into the capsule 6 in the capsule extraction position, typically under high pressure. A beverage outlet 40 is arranged to capture the extracted beverage and convey it from the extraction unit 32.

The extraction unit 32 is arranged to prepare a beverage by the application of pressurised (e.g. at 10-20 Bar), heated (e.g. at 50-98 degrees C.) fluid to the precursor material within the capsule 6. The pressure is increased over a predetermined amount of time until a pressure of a rupturing portion (not illustrated in FIG. 4A, 4B) of the capsule 6 is exceeded, which causes rupture of said portion and the beverage to be dispensed to the beverage outlet 40.

In variant embodiments, which are not illustrated, although the injection head and beverage outlet are illustrated as arranged respectively on the closing portion and capsule holding portion, they may be alternatively arranged, including: the injection head and beverage outlet are arranged respectively on the capsule holding portion and closing portion; or both on the same portion, e.g. on either the holding portion or closing portion. Moreover, the extraction unit may include both parts arranged as a capsule holding portion, e.g. for capsules that are symmetrical about the flange, including a Nespresso® Professional capsule.

Examples of suitable extraction units are provided in EP 1472156 A1 and in EP 1784344 A1, which are incorporated herein by reference, and provide a hydraulically sealed extraction unit.

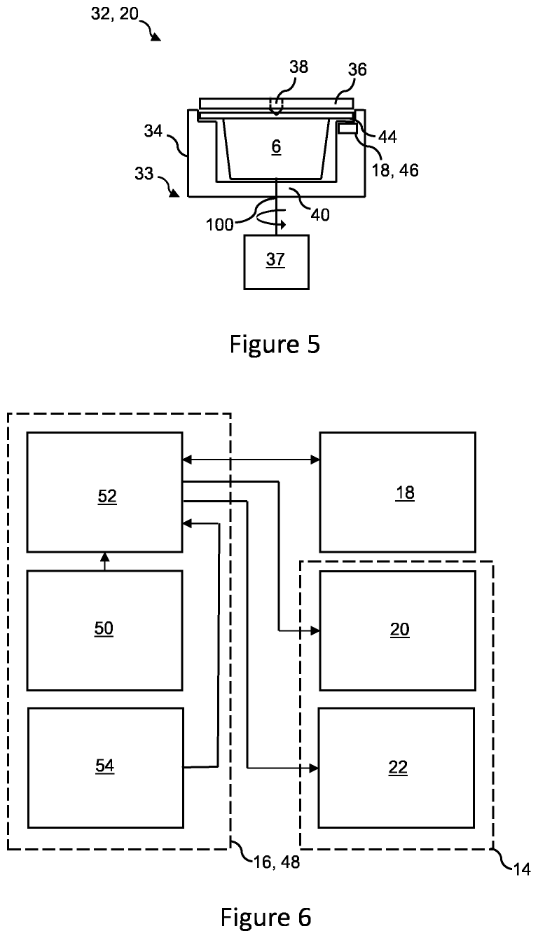

Referring to FIG. 5, in a second example of the container processing unit 20, the extraction unit 32 is as described for the first example, however the extraction unit 32 operates at a lower fluidic pressure and by centrifugation. In particular, the extraction unit 32 includes a rotation mechanism 33 that includes a capsule holing portion 34 to hold the capsule 6 and a drive system 37 to rotate said capsule holder 35.

The outlet 30 of the fluid conditioning system 22 is arranged on the closing portion 36 as an injection head 38 to inject the conditioned fluid into a centre of the capsule 6 through a closing member of the capsule 6 as will be discussed. The rotation mechanism 33 rotates the capsule to effect transmission of the conditioned fluid radially outwards through precursor material in the capsule 6 and out through peripheral arranged puncture points (not illustrated) in the closing member. An example of a suitable capsule is a Nespresso® Vertuo capsule. A suitable example is provided in EP 2594171 A1, which is incorporated herein by reference.

In a third example, (which is not illustrated) the capsule processing unit operates by dissolution of a beverage precursor that is selected to dissolve under high pressure and temperature fluid. The arrangement is similar to the extraction unit of the first and second example, however the pressure is lower and therefore a sealed extraction unit is not required. In particular, fluid can be injected into a lid of the capsule and a rupturing portion which is located in a base of a storage portion of the capsule. An example of a suitable capsule is a Nespresso® Dolce Gusto capsule. Examples of suitable extraction units are disclosed in EP 1472156 A1 and in EP 1784344 A1, which are incorporated herein by reference.

In a fifth example, (which is not illustrated) the container processing unit is arranged as a mixing unit to prepare a beverage or foodstuff precursor that is stored in a container that is a receptacle, which is for end user consumption therefrom. The mixing unit comprises an agitator (e.g. planetary mixer; spiral mixer; vertical cut mixer) to mix and a heat exchanger to heat/cool the beverage or foodstuff precursor in the receptacle. A fluid supply system may also supply fluid to the receptacle. An example of such an arrangement is provided in WO 2014067987 A1, which is incorporated herein by reference.

In a sixth example, (which is not illustrated) the container processing unit is arranged as a dispensing and dissolution unit. The dispensing and dissolution unit is arranged to extract a single serving portion of beverage or foodstuff precursor from a storage portion of the machine (which can include any multi-portioned container including a packet or box). The dispensing and dissolution unit is arranged to mix the extracted single serving portion with the conditioned fluid from the fluid conditioning system, and to dispense the beverage or foodstuff into a receptacle.

### Code Reading System

Referring to FIGS. 4A and 4B, the code reading system 18 is arranged to read a code 44 arranged on a closing member of the container 6. The code reading system 18 is integrated with the extraction unit 32 of first example of the container processing unit 20. The code 44 is read with the extraction unit 32 in the capsule extraction position (as shown in FIG. 4B).

The code reading system 18 includes an image capturing unit 46 to capture a digital image of the code 44. Examples of a suitable image capturing unit 46 include a Sonix SN9S102; Snap Sensor S2 imager; an oversampled binary image sensor; other like system.

The electrical circuitry 16 includes image processing circuitry (not illustrated) to identify the code in the digital image and extract preparation information. An example of the image processing circuitry is a Texas Instruments TMS320C5517 processor running a code processing program.

Referring to FIG. 5, for the second example of container processing unit 20 the code reading system 18 is alternatively arranged to read a code 44 from an underside of a flange portion of the container 6. The code 44 is read based on rotation of the code 44 relative a code reader 46 of the code reading system 18. The code 44 is read with the extraction unit 32 in the capsule extraction position (as shown in FIG. 5), with the rotation mechanism 33 rotating the container 6.

The code reading system 18 includes a code reader 46 to capture a code signal of the code 44. Examples of a suitable image code reader 46 include a photo diode or other electrical componentry that can distinguish between elements of the code (as will be discussed). The code reader may be operable in the infrared and/or visible wavebands. The code reader 46 includes a lighting unit (e.g. an infrared and/or visible light source), not illustrated, to illuminate to code for reading. In variant embodiments, which are not illustrated, the code reader can be implemented as the image capturing unit, as discussed above, or with another suitable reading system.

In variant embodiments, which are not illustrated, the code reading system is separate from the container processing unit including: it is arranged in a channel that the user places the container in and that conveys the container to the container processing unit; it is arranged to read a code on a receptacle, which is positioned to receive a beverage from an beverage outlet of a dispensing and dissolution unit. In further variant embodiments, which are not illustrated, the code reading system is arranged to read a code at a different location of the container, e.g. on a storage portion.

### Control Electrical Circuitry

Referring to FIG. 6, the electrical circuitry 16 is implemented as control electrical circuitry 48 to control the processing unit 14 to execute a preparation process.

The electrical circuitry 16, 48 at least partially implements (e.g. in combination with hardware) an: input unit 50 to receive an input from a user confirming that the machine 4 is to execute a preparation process; a processor 52 to receive the input from the input unit 46 and to provide a control output to the processing unit 14, and; a feedback system 54 to provide feedback from the processing unit 14 during the preparation process, which may be used to control the preparation process.

The input unit 50 is implemented as a user interface, which can include one or more of: buttons, e.g. a joystick button or press button; joystick; LEDs; graphic or character LDCs; graphical screen with touch sensing and/or screen edge buttons; other like device; a sensor to determine whether a container has been supplied to the machine by a user.

The feedback system 54 can implement one or more of the following or other feedback control based operations:
a flow sensor to determine a flow rate/volume of the fluid to the outlet 30 (shown in FIG. 3) of the fluid supply system 22, which may be used to meter the correct amount of fluid to the container 6 and thus regulate the power to the pump 26;
a temperature sensor to determine a temperature of the fluid to the outlet 30 of the fluid supply unit 22, which may be used to ensure the temperature of fluid to the container 6 is correct and thus regulate the power to the heat exchanger 28);
a level sensor to determine a level of fluid in the reservoir 24 as being sufficient for a preparation process;
a position sensor to determine a position of the extraction unit 32 (e.g. a capsule extraction position or a capsule receiving position).

It will be understood that the electrical circuitry 16, 44 is suitably adapted for the other examples of the processing unit 14, e.g.: for the second example of the container processing system the feedback system may be used to control speed of rotation of the capsule.

### Container

Referring to FIG. 8, an example of a container 6, that is for use with the processing unit 14 arranged with an extraction unit, and comprises the container 6 arranged as a capsule. The capsule includes: a body 57 having a storage portion 58 and a flange portion 60, and; a closing member 56 to close the storage portion 58.

The storage portion 58 includes a cavity for storage of the precursor material (not illustrated). The closing member 56 closes the storage portion 58 and comprises a flexible membrane. The flange portion 60 is arranged integrally with the storage portion 58 and presents a flat surface for connecting the closing member 56 to the storage portion 58 to hermetically seal the precursor material. The capsule 6 has a diameter of 2-5 cm and an axial length of 2-4 cm.

In variant embodiments, which are not illustrated, the body of the container can have various shapes including: hemispherical; curved; rectangular in section; frustoconical, and; other like shapes. The closing member may be arranged as a rigid member, rather than a membrane. The container may be formed of two similar or identical storage portions that are connected at a flange, hence the closing member can me omitted. The closing member may connect to the storage portion, hence the flange portion may be omitted.

Suitable examples of containers and/or closing members in terms of shapes, dimensions and/or materials are know from any of the cartridges, capsules and pods for portioned flavouring ingredients used by Nespresso™ (Original Line, Professional Line, Vertuo Line) and Nestle Dolce Gusto™ and Nestle Special-T™. The materials may thus include metal, for instance aluminium, plastic and/or paper. The materials are preferably biodegradable and/or recyclable. Suitable use, e.g. extraction, processes and systems are also known from Nespresso™, Nestle Dolce Gusto™ or Nestle Special-T™.

Constructional, manufacturing and/or (beverage) extraction details of containers and/or closing members are for instance disclosed in EP 2155021, EP 2316310, EP 2152608, EP2378932, EP2470053, EP2509473, EP2667757 and EP 2528485.

### Arrangement of Code

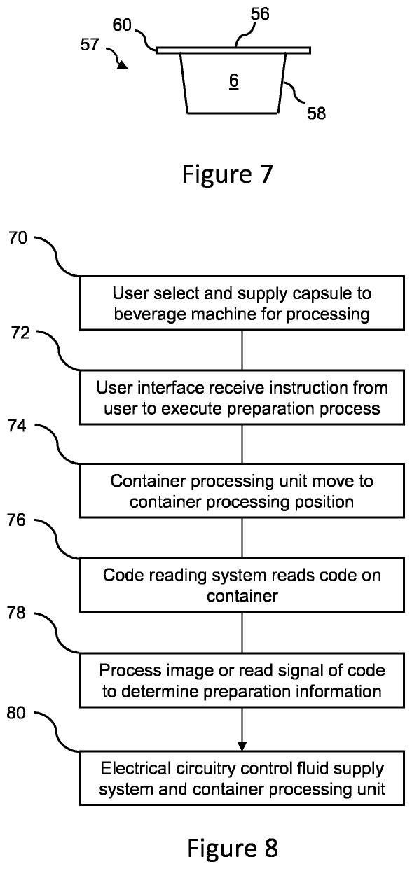

Referring to FIGS. 4A, 4B and 5, the code 44 code is arranged on an exterior surface of the container 6 in any suitable position such that it can be read by the code reading system 18. Referring to FIG. 7, the code 44 (not illustrated in FIG. 7) may be arranged on one or more of the following positions: the closing member 56; a lower surface of the flange portion 60 that faces away from the closing member 56; the storage portion 58.

### Process for Preparing a Beverage

Referring to FIG. 8, the execution of a process for preparing a beverage/foodstuff from precursor material is illustrated:

Block 70: a user supplies a container 6 to the machine 4.

Block 72: the electrical circuitry 16 (e.g. the input unit 50 thereof) receives a user instruction to prepare a beverage/foodstuff from precursor, and the electrical circuitry 16 (e.g. the processor 52) initiates the process.

Block 74: the electrical circuitry 16 controls the processing unit 14 to process the container (e.g. in the first or second example of the container processing unit 20, the extraction unit 32 is moved from the capsule receiving position (FIG. 4A) to the capsule extraction position (FIG. 4B, FIG. 5).

Block 76: the electrical circuitry 16 controls the code reading system 18 to read the code 44 on the container 6 and provide a digital image of the code or a code signal related to the code.

Block 78: the code processing circuitry of the electrical circuitry 16 processes the digital image to or code signal extract the preparation information and determine a recipe of parameters.

Block 80: the electrical circuitry 16, based on the preparation information, executes the preparation process by controlling the processing unit 14. In the first or second example of the processing unit this comprises: controlling the fluid conditioning system 22 to supply fluid at a temperature, pressure, and time duration specified in the preparation information to the container processing unit 20.

The electrical circuitry 16 subsequently controls the container processing unit 20 to move from the capsule extraction position though the capsule ejection position to eject the container 6 and back to the capsule receiving position.

In variant embodiments, which are not illustrated: the above blocks can be executed in a different order, e.g. block 72 before block 70 or block 76 before block 74 or block 76 before block 72 (e.g. the container is detected as being present, by the code reading system or a dedicated sensor, and is read automatically without a user input and user input may follow to confirm execution of the preparation process); some block can be omitted, e.g. where a machine stores a magazine of capsules block 70 can be omitted; alternatively at blocks 70 to 76 a user presents the code of the container to the code reading system and after it is read opens said container and dispenses the pre-precursor material into the processing unit. Moreover, the container processing unit may be manually moved between the extraction position and capsule receiving position.

Blocks 76 and 78 may be referred to a code reading process. Block 80 may be referred to as the preparation process. The electrical circuitry 16, includes instructions, e.g. as program code, for the preparation process (or a plurality thereof). In an embodiment the processor 52 implements the instructions stored on a memory (not illustrated).

As part of the preparation process, the electrical circuitry 16 can obtain additional preparation information via the computer network 12 from the server system 8 and/or peripheral device 10 using a communication interface (not illustrated) of the machine.

### Code Formation

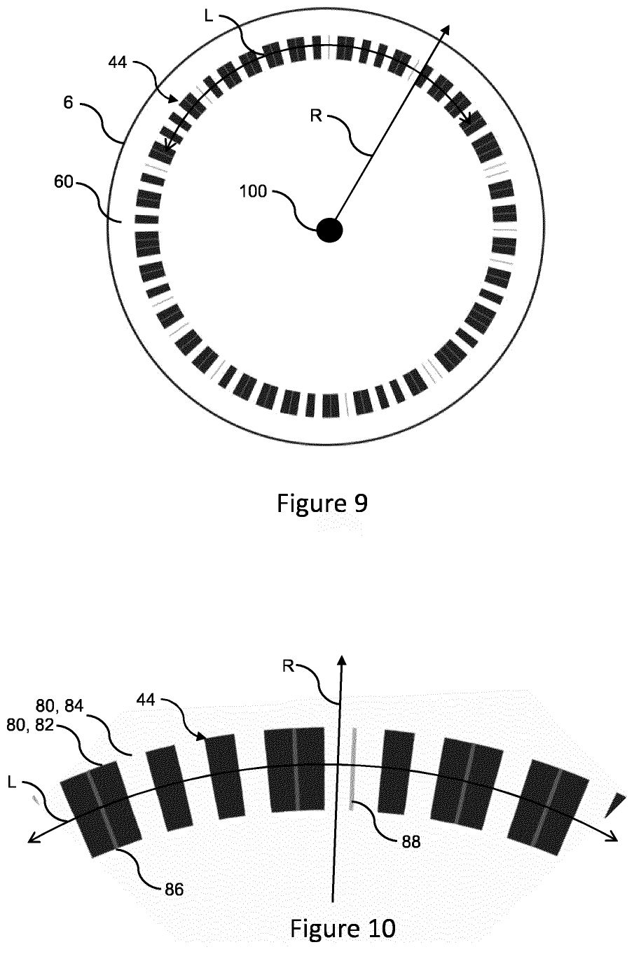

Referring to FIGS. 9 and 10, the code 44 on the flange portion 60 of the container 6 is arranged to be read by a code reading system 18 sequentially when the container 6 is rotated about the axis of rotation 100 (as also illustrated in FIG. 5). The code 44 is arranged on a circumferentially extending virtual line L, which is spaced radially in a radial direction R from the rotational axis 100.

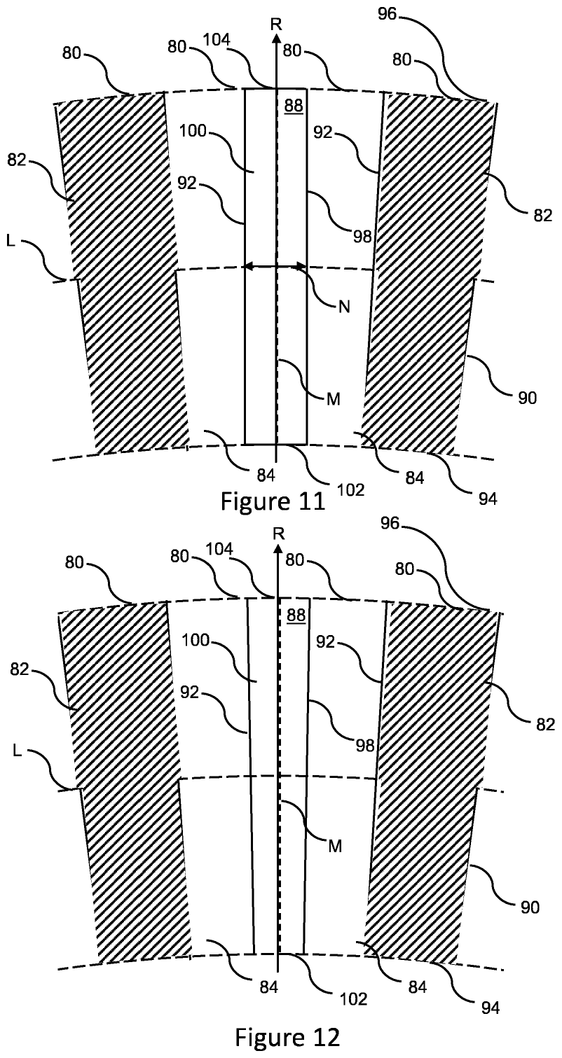

The code 44 is arranged as a plurality of discrete positions 80 (as best seen in FIGS. 11 and 12), which are arranged at predefined positions around the entire circumferential line L (i.e. over a full revolution) in the same way that a Roulette wheel is partitioned into red/black and green pockets. The discrete positions 80 are equally spaced, with the same geometry, and directly adjoin each other such that there is no gap therebetween. Adjoining edges of the discrete positions 80 directly bound each other.

As is best seen in FIG. 10, a primary element 82 or a primary element absence 84 at a discrete position 80 encodes the preparation information (e.g. as a logical 1 or a 0), as will be discussed.

As is best seen in FIG. 10, boundary elements 86 are arranged at a boundary between two or more adjoining primary elements 82. Moreover, boundary elements 88 are arranged at a boundary between two or more adjoining primary element absences 84.

The boundary elements 86, 88 are of different reflective or other properties to enable them to be identified from a primary element 82 or a primary element absence 84, examples of which will be provided.

The boundary elements 86 are only arranged at a boundary between two or more adjoining primary elements 82, and the boundary elements 88 only arranged at a boundary between two or more adjoining a primary element absence 84. Hence a boundary between a primary element 82 and a primary element absence 84 does not include a boundary element.

In variant embodiments, which are not illustrated: the code comprises only boundary elements between the primary elements and not between the primary element absences; the code comprises only boundary elements between the primary element absences and not between the primary elements; some, not all, of said boundaries may comprise boundary elements.

The boundary elements 86 entirely separate the adjoining primary elements 82, and the boundary elements 88 entirely separate adjoining primary element absences 84. By entirely separate it is meant that an active portion (i.e. a portion that is read the code reader) that forms the primary element 82 does not contact another primary element. With the same being true for the primary element absence 84.

Referring to FIG. 11, the discrete positions 80 are arch shaped. They have a leading edge 90 and a trailing edge 92 that is aligned in the radial direction R. Wherein leading is defined relative to the foremost clockwise position and trailing is defined relative to the foremost anti-clockwise position They have an inner radial edge 94 and an outer radial edge 96 that curves circumferentially to correspond to the radial position they occupy. Wherein inner and outer is defined in respect of the radial position R, with inner being proximal most the axis 100.

The boundary elements 86, 88 (only element 88 is shown) are rectilinear, and in particular are rectangular, wherein a mid-point line M in the circumferential direction L is aligned to the radial direction R. And the leading edge 98 and trailing edge 100 are aligned to the mid-point line M and the inner radial edge 102 and outer radial edge 104 are orthogonal to the mid-point line M.

Referring to FIG. 12, the discrete positions 80 are arch shaped as described in FIG. 11, and the boundary elements 86, 88 are alternatively arch shaped as described for the discrete positions 80 in FIG. 11.

In variant embodiments, which are not illustrated: the discrete positions may be rectilinear, including rectangular, as discussed for the boundary element in FIG. 11; the discrete positions and/or boundary elements can be formed with straight leading and trailing edges (which can be parallel or inclined) and with a curved inner and a curved outer radial edge or with a straight inner and straight outer radial edge; combinations of curved and straight inner and outer edges may also be implemented for any of the aforedescribed shapes; other suitable shapes may also be implemented.

In the above examples, the boundary elements 86, 88 have an and average arc length of less than 30% or 25% and greater than 5% or 10% or 15% of an average arc length of a discrete position 80.

For an arch shaped boundary element 86, 88 or discrete position 80, the average arc length (which can be measured in degrees or radians) is merely the arc length at any position along he radial direction R since this does not vary with radial position.

For a rectilinear, rectangular arch shaped boundary element 86, 88 or discrete position 80, as shown for the boundary element 88 in FIG. 11, the average arc length (which can be measured in degrees or radians) is the average taken along the radial positions. Since the boundary element 88 in FIG. 12 is linear, the average arc length is measured at the radial mid-point N between the radial inner 102 and radial outer 104 edge.

For other shapes of boundary elements or discrete positions, the average arc length may be defined as above.

In a first example, the discrete positions are arch shaped, and each have an equal arc length of 2.6 degrees±20% or 10% or 5%.

In a second example, the discrete positions are rectilinear shaped each have an average arc length of 2.6 degrees±20% or 10% or 5%.

In either the first or second example, the boundary elements are arch shaped and each have an equal arc length of 0.5 degrees±5% or 10% or 20%.

In either the first or second example, the boundary elements are rectilinear and rectangular and each have an average arc length of 0.5±5% or 10% or 20%. Or alternatively put they have a width of 0.25 mm±5% or 10% or 20%.

In either the first or second example, the code 44 is arranged with 140 discrete positions circumferentially, with an inner edge radii of 48.9 mm and an outer edge radii of 54.9 mm.

A primary element 82 arranged at a discrete position 80 is configured to reflect comparatively less power in the infrared wavebands than a primary element absence 84. A boundary element 86, 88 is configured to reflect comparatively more power in the infrared wavebands than the primary element and comparatively less power in the infrared wavebands than the primary element absence. Such an arrangement may be achieved by printing a primary element with a carbon black ink and a boundary element with a carbon black ink with less carbon or the same ink but with less density and/or sized print spots. Examples of which will be provided.

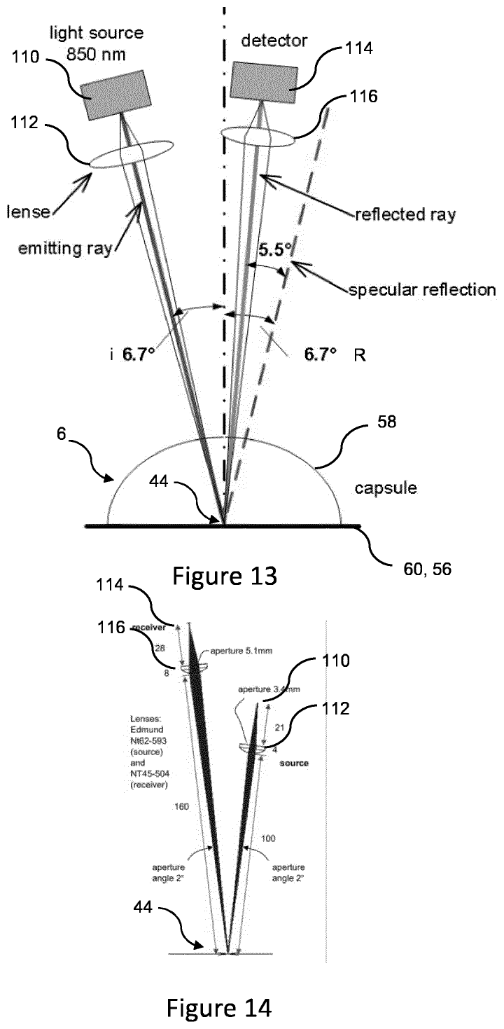

In variant embodiments, which are not illustrated: a primary element arranged at a discrete position is configured to reflect comparatively more power in the infrared wavebands than a primary element absence, and that the boundary element has a reflected power of between the two. It will be understood that the disclosed experimental values associated with FIGS. 13 and 14 discussed following can be applied to such a variant.

In variant embodiments, which are not illustrated: a boundary element is configured to reflect the same (including substantially the same) power in the infrared wavebands as an adjoining primary element or primary element absence and have different reflective properties from the primary element and/or primary element absence in the visible wave bands. Such an example may be provided by implementing a ink with no carbon for the boundary elements adjoining the primary element absences such that they are not visible in the infrared spectrum but with a colour that is visible in the visible spectrum. Examples of which will be provide.

Referring to FIGS. 13 and 14, an experimental setup for verifying the reflective properties of the code 44 is provided.

The experimental setup includes:
a 850 nm, 520 μW laser source 110, projecting a distance of 21 mm to an Edmund Nt62-593 lens 112 with a 4 mm thickness, with a 3.4 mm aperture and a distance of 100 mm from said lens to the code 44 at an angle of incidence to a normal to the code of 6.7 degrees, and;
a photo sensitive detector 114 at 850 nm, arranged a distance of 28 mm from an Edmund Nt45-504 lens 116 with a 8 mm thickness, with a 5.1 mm aperture and a distance of 160 mm from said lens to the code 44 at an angle of reflection to a normal to the code of 1.2 degrees,

With the disclosed experimental setup and the code 44 arranged as flat:
a primary element 82 is configured to reflect less than 0.4 μW;
a primary element absence 84 is configured to reflect more than 1.1 μW, and;
a boundary element is configured to reflect greater than 0.4 μW and less than 1.1 μW.

In embodiments the primary elements 82 and the boundary elements 86, 88, are formed by printing. This may be directly on to the container 6, e.g. the flange thereof, or on to a separate substrate (not illustrated), for subsequent attachment to the container, e.g. on the flange thereof.

The material on to which the code is formed may for example be a metal (e.g. aluminium) or paper. The material may be selected as having the above properties of a primary element or an absence thereof, thus obviating the formation of both a primary element and an absence.

The same printing process may be used for the boundary elements, with the primary elements formed with a greater density and/or size of units forming the print than for those of the boundary elements, e.g. by raster printing. As an example, the ink that is used for the printing process may be a carbon black ink.

In variant embodiments, which are not illustrated; the elements are alternatively formed, including by embossing, engraving or other suitable means; the primary element absences and the boundary elements are formed by printing and the primary elements are selected as the surface of the material.

### Code Encoding

A primary element 82 or a primary element absence 84 at a discrete position 80 encodes information as a logical 1 or a 0. The information is encoded as a data portion (not illustrated) for storing the preparation information, and a finder sequence for locating the data portion.

The boundary elements 86, 88 do not encode the preparation information, e.g. they are just present to enable differentiation between primary elements 82 that are adjoining, the same being understood for the primary element absences 84.

The finder sequence (not illustrated) comprises a predefined reserved sequence of logical 1s and/or 0s, which is identifiable when processing the code 44. For example, the code processing program implemented by the electrical circuitry 16 can search though strings of 1s and 0s in the code signal to locate the finder sequence(s). The data sequence is arranged at a known position with respect to the finder sequence, e.g. immediately after or distributed within the finder sequence. Hence with the finder sequence located, the data sequence can then be located and decoded. The data sequence may be decoded based on a rule stored on the electrical circuitry 16 (e.g. via electronic memory) of the machine 2. A specific example of such a code is provide in EP 2594171 A1.

### Method

A method of processing the code 44, to obtain the preparation information, which is executed as block 78 in reference to the process of FIG. 8 (subsequent to block 76 in which a code read signal is obtained by implementing relative rotation between the capsule 6 comprising the code 44 and a code reader) comprises:

Block 100: processing the code read signal to identify in said signal an absence or presence of a primary element 82 at a discrete position 80 based on identifying an boundary element 86, 88 arranged at a boundary between two adjoining primary elements, and/or at a boundary between two adjoining absences of elements.

Referring to FIG. 14, as an example of this block, line 110 illustrates a code read signal of the example code 44 (shown below the graph) with boundary elements 86, 88, whereas line 112 illustrates the code read signal for the same code 44, but without the boundary elements 86, 88 present.

The code processing program is implemented to search for the mid-level absorbances 114 in the signal that is caused by the boundary elements, 86, 88, and to use these to identify where primary elements 82 (or primary element absences 84) adjoin each other. For example, if a high or a low absorbance of a primary element or respective absence thereof is detected, a logical operation of searching for a subsequent mid/level absorbance 114 is initiated and if determined as present then it can be assumed that there are two adjoining primary elements or absences.

It will be understood that the mid-level absorbances 114 enable the positions of said adjoining primary elements (or absences) to be accurately located, and is a particular advantage when a large number of primary elements (or absences) are arranged in a row.

Block 102: processing the code to extract the preparation information. With the primary elements 82 and primary element absences 84 determined for the discrete positions 80, a string of logical 1s and 0s is determined. This string (or sub-strings thereof) are searched for the finder sequence (as discussed above). Once the finder sequence is located, the data sequence can be located and decoded into the preparation information using a rule.

The processing unit 14 can then be controlled based on the preparation information to execute a preparation process. Since for the second example of the container processing unit 20 the container 6 is processed by rotating the container, the preparation process can be executed whilst the code reading process is executed (or immediately after).

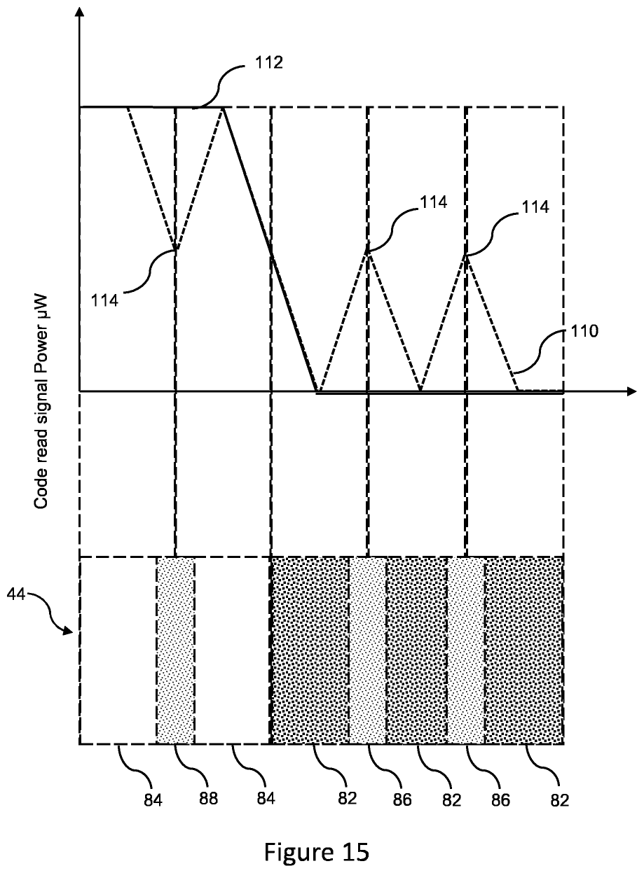

For variant embodiments, in which a boundary element is configured to reflect the same power in the infrared wavebands as an adjoining primary element or primary element absence and have different reflective properties from the primary element and/or primary element absence in the visible wave bands, the graphical plot of FIG. 15 may be different. For example, a first line may represent the code read signal for the discrete positions in the infrared wave bands and a separate second line may represent the code read signal for the boundary elements in the visible wavebands. The two code read signals being synchronised with respect to time, can be overlaid and the individual discrete positions identified using the identified boundary elements as in the above example.

For machines 2 that implement a code processing program that is not programmed to identify boundary elements, e.g. existing or legacy machines, the processing step at block 100 is adapted accordingly, e.g. as in EP 2594171 A1.

In a variant of the above method, the code read signal 110 is used to determine an angular velocity of a container 6 whilst it is being rotated by the machine 2, the method comprises:

Block 104: (which is executed subsequent to block 100) determining the angular velocity based on there being a known number of discrete positions 80 per full rotation of the code 44. The known number of discrete positions can be stored in an electrical circuitry 16 with electronic memory.

For example, since the mid-level absorbances 114 enable more accurate location of all the discrete positions 80 (e.g. because adjoining elements 82 are more likely to be identified as two elements rather than one), this means that the number of discrete positions 80 for a given arc length (including a full rotation) can be accurately identified.

If, for example there are 140 discrete positions 80 for a full revolution of the code 44, and all 140 are being identified every 0.5 second, this means an angular velocity of 1080 degrees/second (180 RPM) is calculated.

The angular velocity can be calculated during the preparation process and controlled as part of the preparation process using a predefined angular velocity encoded in the preparation information and/or as a default parameter stored on the machine. Hence the method of determining angular velocity may be implemented as part of the preparation process subsequent to the code reading process.

A method of encoding preparation information with the code 44 comprises:

Block 120: arranging the code circumferentially to be read sequentially when the container 6 is rotated about an axis of rotation 100;

Block 122 forming the code 44 as a plurality of directly adjoining discrete positions 80, with and an absence or presence of a primary element 82 at a discrete position encoding the preparation information,

Block 124 forming the code 44 with boundary elements 86, 88 at a boundary of two adjoining primary elements 82, and/or at a boundary of two adjoining primary element absences 84, which are of different reflective properties to the primary element or primary element absences. Said forming may be implemented by printing as discussed above.

It will be appreciated that any of the disclosed methods (or corresponding apparatuses, programs, data carriers, etc.) may be carried out by either a host or client, depending on the specific implementation (i.e. the disclosed methods/apparatuses are a form of communication(s), and as such, may be carried out from either ‘point of view’, i.e. in corresponding to each other fashion). Furthermore, it will be understood that the terms “receiving” and “transmitting” encompass “inputting” and “outputting” and are not limited to an RF context of transmitting and receiving radio waves. Therefore, for example, a chip or other device or component for realizing embodiments could generate data for output to another chip, device or component, or have as an input data from another chip, device or component, and such an output or input could be referred to as “transmit” and “receive” including gerund forms, that is, “transmitting” and “receiving”, as well as such “transmitting” and “receiving” within an RF context.

As used in this specification, any formulation used of the style “at least one of A, B or C”, and the formulation “at least one of A, B and C” use a disjunctive “or” and a disjunctive “and” such that those formulations comprise any and all joint and several permutations of A, B, C, that is, A alone, B alone, C alone, A and B in any order, A and C in any order, B and C in any order and A, B, C in any order. There may be more or less than three features used in such formulations.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

Unless otherwise explicitly stated as incompatible, or the physics or otherwise of the embodiments, example or claims prevent such a combination, the features of the foregoing embodiments and examples, and of the following claims may be integrated together in any suitable arrangement, especially ones where there is a beneficial effect in doing so. This is not limited to only any specified benefit, and instead may arise from an “ex post facto” benefit. This is to say that the combination of features is not limited by the described forms, particularly the form (e.g. numbering) of the example(s), embodiment(s), or dependency of the claim(s). Moreover, this also applies to the phrase “in one embodiment”, “according to an embodiment” and the like, which are merely a stylistic form of wording and are not to be construed as limiting the following features to a separate embodiment to all other instances of the same or similar wording. This is to say, a reference to ‘an’, ‘one’ or ‘some’ embodiment(s) may be a reference to any one or more, and/or all embodiments, or combination(s) thereof, disclosed. Also, similarly, the reference to “the” embodiment may not be limited to the immediately preceding embodiment.

As used herein, any machine executable instructions, or compute readable media, may carry out a disclosed method, and may therefore be used synonymously with the term method, or each other.

The foregoing description of one or more implementations provides illustration and description, but is not intended to be exhaustive or to limit the scope of the invention to the precise form disclosed. Modifications and variations are possible in light of the above teachings or may be acquired from practice of various implementations of the present disclosure.

### LIST OF REFERENCES

2 System
4 Machine
14 Processing unit
20 Container processing unit (first/second example)
32 Extraction unit
34 Capsule holding portion
36 Closing portion
38 Injection head
40 Beverage outlet
33 Rotation mechanism
37 Drive system
22 Fluid conditioning system
24 Reservoir
26 Pump
28 Heat exchanger
30 Outlet
42 Loose material processing unit
16 Electrical circuitry
48 Control electrical circuity
50 Input unit
52 Processor
54 Feedback system
18 Code reading system
46 Image capturing unit
6 Container (Capsule)
56 Closing member
58 Storage portion
60 Flange portion
44 Code
80 Elements
82 Primary Element
84 Secondary element
L Virtual line
82 Surround
100 Axis
R Radial direction
8 Server system
10 Peripheral device
12 Computer network

1. A container arranged for containing a precursor material for use with a machine for preparing a beverage and/or foodstuff, the container including a machine-readable code storing preparation information for use with a preparation process performed by said machine, the code comprising a plurality of elements,
the code is arranged as a plurality of directly adjoining discrete positions and an absence or presence of a primary element at a discrete position encodes the preparation information,
boundary elements are arranged at a boundary between two or more adjoining primary elements, and/or at a boundary between two or more adjoining primary element absences,
the boundary elements are of different reflective properties to a primary element and/or a primary element absence, and
the discrete positions and the boundary elements of the code are arranged circumferentially to be read sequentially when the container is rotated about an axis of rotation relative a code reader.

2. The container of claim 1, wherein the boundary elements are only arranged at a boundary between two or more adjoining primary elements, and/or at a boundary between two or more adjoining primary element absences so that a boundary between a primary element and a primary element absence does not include a boundary element and the boundary elements entirely separate the adjoining primary elements and/or adjoining primary element absences.

3. The container of claim 1, wherein a boundary element does not encode the preparation information.

4. The container of claim 1, wherein the boundary elements have:
have an average arc length of less than 50% and greater than 5% of an average arc length of a discrete position.

5. The container of claim 1, wherein:
the discrete positions have an average arc length of 2.6 degrees±20%;
and the boundary elements have an average arc length of 0.5 or 0.44 degrees±5%.

6. The container of claim 1, wherein the boundary elements are configured to be visible to a code reader in visible or ultraviolet wave bands and not visible to the code reader in infrared wavebands or have the same viability as a primary element or primary element absence in the infrared wavebands.

7. The container of claim 1, wherein:
a primary element arranged at a discrete position is configured to reflect comparatively less power in the infrared wavebands than a primary element absence, and;
a boundary element is configured to reflect comparatively more power in the infrared wavebands than the primary element and comparatively less power in the infrared wavebands than the primary element absence.

8. The container of claim 1, wherein, for an experimental setup as defined herein with reference to the accompanying description, which comprises:
a 850 nm, 520 μW laser source, projecting a distance of 21 mm to a Nt62-593 lens with a 3.4 mm aperture and a distance of 100 mm from said lens to the code at an angle of incidence to a normal to the code of 6.7 degrees, and;
a photo sensitive detector at 850 nm, arranged a distance of 28 mm from a Nt45-504 lens with a 3.4 mm aperture and a distance of 160 mm from said lens to the code at an angle of reflection to a normal to the code of 1.2 degrees,
a primary element is configured to reflect less than 0.4 μW;
a primary element absence is configured to reflect more than 1.1 μW; and
a boundary element is configured to reflect greater than 0.4 μW and less than 1.1 μW.

9. The container of claim 1, wherein:
the primary elements or primary element absences, and;
the boundary elements,
are formed by printing onto the container, and the primary elements or primary element absences comprise a greater density and/or size of units forming the print than the boundary elements.

10. The container of claim 1, wherein the discrete positions encode a logical 1 or 0 based on the absence or presence of a primary element, wherein a predetermined sequence of logical 0s and 1s define a locator sequence for locating a data sequence of logical 0s and 1s,
and the code is arranged on an exterior wall of a flange portion, that interconnects a storage portion and a closing member, wherein said exterior wall faces away from an exterior wall of the closing member.

11-12. (canceled)

13. A method of encoding preparation information with a code, the method comprising:
forming the code as a plurality of directly adjoining discrete positions, with an absence or presence of a primary element in a discrete position encoding the preparation information,
forming boundary elements at a boundary of two adjoining primary elements, and/or at a boundary of two adjoining primary element absences, wherein the boundary elements are formed with different reflective properties to a primary element or a primary element absence, and
wherein the discrete positions and the boundary elements of the code are arranged circumferentially to be read sequentially when the container is rotated about an axis of rotation relative a code reader.

14. A method of reading preparation information for use in a preparation process in which a machine is controlled based on the preparation information to prepare a beverage and/or foodstuff, the method comprising:
implementing relative rotation between a container comprising a code and a code reader;
obtaining a signal from the code reader based on the code;
processing the signal to identify in said signal an absence or presence of a primary element at a discrete position based on identifying an boundary element arranged at a boundary between two adjoining primary elements, and/or at a boundary between two adjoining primary element absences, wherein the boundary elements are identified in the signal based on them having different reflective properties to a primary element and/or a primary element absence and;
extracting the preparation information based on the identified absence or presence of a primary element.

15-18. (canceled)
